(19) United States
(12) Patent Application Publication
(10) Pub. No.: US 2016/0033990 A1
(43) Pub. Date: Feb. 4, 2016

(54) Systems and Methods for Determining Absolute Time Corresponding to Relative Time-Stamped Events

(71) Applicant: Innovolt, Inc., Atlanta, GA (US)

(72) Inventor: Vincent P. Luciani, Charlotte, NC (US)

(21) Appl. No.: 14/445,712

(22) Filed: Jul. 29, 2014

(51) Int. Cl. G06F 1/14

(52) U.S. Cl. CPC G06F 1/14

(57) ABSTRACT

System and methods for transferring time-stamped event data and correcting the relative time associated with the time-stamped event to the correct “absolute” time, wherein “absolute” time is an official reference time. A time stamp relative to a predetermined event is obtained from a real time clock (RTC) that is unsynchronized to absolute time and associated with event data, as may be acquired by a data monitoring component. The relative time of the event data is correlated with “absolute” time to find a correction factor or time offset that defines the variation between the relative time and the absolute time. The time offset is applied to some or all of a plurality of event data sets transferred to other components in a utilization system to provide time corrected event data sets.

### TECHNICAL FIELD

The present systems and methods relate generally to the creation of synchronized time-stamped events, and more particularly relate to the conversion of unsynchronized time-stamped events marked by a relative time derived from a clock associated with the source of the event to a time synchronized with an absolute or real time clock.

### BACKGROUND

Many electronic monitoring and/or control devices contain a real time clock (RTC) or other timekeeping device in order to time stamp events associated with the monitoring and/or control. For example, an AC line voltage monitor measures a line voltage; when a deviation from nominal voltage is sensed, the deviation event is marked with a time stamp. Similarly, a water leak monitor can also contain an RTC or other timekeeping device to mark an event indicating that a water leak is sensed. Signals or messages associated with the events are often communicated to another location for recording or action.

A time stamp for an event provides valuable information as to when events occur in order to correlate this event with an effect on another entity, e.g. a monitoring or control entity and its associated equipment. For instance, if an AC line monitor senses a voltage deviation on a branch circuit at a particular point in time, and at the same time, an error or malfunction occurs in a load device connected to that same branch circuit, it may be surmised that the voltage deviation may have caused the error or malfunction in the load device.

Correlation of disturbance events, errors, and malfunctions in electrical systems can be valuable in troubleshooting system problems. The time stamp of a disturbance event is more useful if it is ultimately accurate and expressed in absolute time (i.e., synchronized with other independently running timekeeping devices) so that it may be correlated with other time-stamped events that may bear a relationship to the disturbance event. However, without some form of clock synchronization, different devices may assign different time stamps to events, rendering a correlation between events uncertain. There is thus a need for an approach for time correlation for events between devices that may have unsynchronized, independent time clocks used for time stamping the events.

One example of the issue arises with an AC line voltage monitor that measures voltage on a power trunk branch, and provides voltage signal to external devices via a network connection to a utilization device such as a fault monitor. The fault monitor and the AC line voltage monitor may be remotely located from each other. However, a significant voltage deviation on the AC line may be correlated and associated with electrical equipment failure connected to a branch of the AC line. In order to determine that the significant voltage deviation is the cause of, or otherwise closely associated with, the electrical equipment failure, the voltage deviation event must be time correlated with the equipment failure event, often by separate and independent data logging equipment. Unless the time clock associated with the AC line voltage monitor is synchronized with the time clock of the equipment failure monitor, there can be a time difference between the time clocks that can affect the correlation of these events.

Furthermore, the time clock associated with the AC line voltage monitor and the time clock of the equipment failure monitor might reflect totally different times as a result of a number of issues (clock skew, drift, reset of the time clock, an arbitrary time on a time clock), so that neither clock is accurately related to an absolute time clock that would allow correlation to be readily determined. Thus, each of these devices may have its own, unsynchronized time clock, which is different to each other and different to an absolute time clock. The time stamped signals from the AC line voltage monitor and the equipment failure monitor in this case would be different relative to both each other and to absolute time, absent a synchronization mechanism that might prove impractical for remote monitoring applications.

While the example presented here is for an AC line voltage monitor, the concepts presented for relative time stamping are applicable to any remote system, monitoring system, etc., that contains an RTC or any other type of timekeeping device.

Remote data collection, monitoring, and/or control devices typically use an on-board timekeeping device such as a real time clock (RTC) to time stamp events. These time stamps are device relative, i.e. the time is kept relative to the device, and not necessarily to absolute time. In devices that use an RTC to time stamp events, it is usually necessary for the device to include a facility to set the time of the on-board RTC. This facility usually includes some sort of display and one or more buttons for the user to set the RTC and receive feedback that the RTC is set properly. In such devices where the time is set by the user, there are at least three sources of inaccuracies: (1) failure to set or reset the RTC to the correct time, (2) lack of a reliable and/or available time reference, and (3) drift of the RTC. Inaccuracies due to failure to set or reset the RTC are self-evident as the system or individual analyzing the time-stamped events is expecting that the time stamps were generated by an accurate timekeeping device. It will be understood by one of ordinary skill in the art that time-keeping devices are subject to drift or skew, wherein drift is defined as the time-keeping device slowly becoming inaccurate over time, and skew is an arbitrary offset that might result from an incorrect time setting. With drift, as time goes on the error amount accumulates and increases.

Furthermore, it is known that many devices that include an on-board RTC have no connection to absolute time to compensate for drift or skew, and may also be subject to occasional reset or initialization operations due to power loss. Many known RTCs, upon power up or reset (e.g. initialization), will revert to a predetermined default start time, e.g. 12:00 AM on Jan. 1, 1970. These clocks, without any ability to be set to actual real time due to remote location and absence of a reliable or absolute time reference, may continue to run without regard to whether the time is anywhere near 12:00 AM on Jan. 1, 1970, and provide device-relative time-stamped event data. Thus, one week (to the minute) after a reset operation at 4:00 PM on Jun. 5, 2014, on such a device, the time on the device RTC will indicate 12:00 PM on Jan. 7, 1970, even though the actual time is 4:00 PM on Jun. 12, 2014. Despite the fact that the RTC is inaccurate as to absolute time, the RTC has been running properly for a week and providing event data that are time stamped with the time that is relative to the device itself. Such device-relative events occurring during that week need to be time-correlated to actual, accurate time in order to associate them with other events.

Therefore, there is a need for a system or method to provide a device that contains an RTC or other timekeeping mechanism for use in remote, unsynchronized monitoring or control applications that do not require user intervention to set the timekeeping device or keep accurate absolute time. Additionally, there is a need for a device for use in remote event monitoring or control to time stamp event data with time relative to the device and convert the relative time to absolute time elsewhere for utilization such as correlation to other events. Further, there is a need for a system or method to reduce the effects of drift or skew of a real time clock as the time is not counted from the initialization of the system, but is kept from the time the event occurs to the time the data is transferred.

### BRIEF SUMMARY OF THE DISCLOSURE

Briefly described, and according to one embodiment, aspects of the present disclosure generally relate to systems and methods for transferring device-relative time-stamped information and correcting the relative time associated with the time-stamped information to the correct “absolute” time, where “absolute” time is an official or reference time determined by the system. In one embodiment, the present system and method creates a time stamp relative to a predetermined event and stores the time stamp and data corresponding to the event in a data store before transferring the event data to components of a system that utilizes the event data. According to one aspect, the relative time is correlated with “absolute” time to find a correction factor or time offset that defines the variation between the relative time on the device and the absolute time. In another aspect, the time offset is applied to some or all of the event data sets transferred to the other components of the system and the time-corrected event data set(s) are transferred to other components of the system. In one aspect, the receiving component of the system calibrates and correlates the relative time to the correct absolute time and modifies the relative time associated with all of the transferred event data sets.

In certain embodiments, the disclosed systems and methods further comprise devices with internal time keeping mechanisms, wherein said internal time keeping mechanism generally starts keeping time at the initial startup of the device and the beginning time is usually a predetermined time or random time relative to the device. According to one aspect, the time stamping device does not require a display or buttons for setting its internal timekeeping component(s). Further, the disclosed systems and methods compensate for drift and skew as they relate to time and common errors associated with timekeeping devices.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary relative-time stamping conversion environment, according to one embodiment of the present disclosure.

FIG. 2 shows an exemplary block diagram of a voltage monitoring system architecture, according to one embodiment of the present disclosure.

FIG. 3, consisting of FIG. 3A and FIG. 3B, is a sequence diagram illustrating an embodiment of a relative time stamping conversion process.

FIG. 4, consisting of FIG. 4A and FIG. 4B, is a sequence diagram illustrating another embodiment of a relative time stamping conversion process.

FIG. 5 is a flow chart illustrating logic of a data collection device, according to one embodiment of the present disclosure.

FIG. 6 is a flow chart illustrating logic of an intermediary device, according to one embodiment of the present disclosure.

FIG. 7 is a block diagram of a memory map and an exemplary relative time stamping conversion process, according to one embodiment of the present disclosure.

FIG. 8 is a block diagram of memory map and another exemplary relative time stamping conversion process, according to one embodiment of the present disclosure.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Definitions/Glossary

“Relative” time: the non-synchronized, free-running time kept by a timekeeping device that has not been set to a correct or absolute time and/or date.

“Absolute” time: the synchronized actual time kept by a timekeeping device that has been set or referenced to the correct time and date.

Time stamp (Ts): the “relative” time associated with an event read from a non-synchronized, free-running timekeeping device that has not been set to the correct time and date at the instant an event occurs.

Relative transfer time (Ttr): the “relative” time read at an instant that time-stamped information is being transferred from an originating apparatus to a receiving apparatus as read from a non-synchronized, free-running timekeeping device located on the originating apparatus that has not been set to the correct time and date.

Absolute transfer time (Tta): the “absolute” time read at the instant that time-stamped information is being transferred from an originating apparatus to the receiving apparatus as read from a synchronized timekeeping device located on the receiving apparatus that has been set to the correct time and date.

Offset time (To): the difference between the Relative Transfer Time (Ttr) and the Absolute Transfer Time (Tta).

Corrected time stamp (Tsc): any Time Stamp (Ts) that has been corrected by either adding or subtracting the Offset Time (To).

Deviation type: a predetermined classification describing the variance between an observed phenomenon and expected behavior.

Event data: data associated with the identification of a predetermined observed phenomenon including, but not limited to deviation type, relative time stamp, current relative time, offset time, etc.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for transferring time-stamped information and correcting the relative time associated with the time-stamped information to the correct “absolute” time, wherein “absolute” time is an official relevant time determined by the system. In one embodiment, the present system and method creates a time stamp relative to a predetermined event and stores the event in a data store before transferring the event data to further components of the present system for utilization. Such utilization may, but is not required to, be to associate a time-stamped event from one device to a different time-stamped event associated with another, independent device having an independent clock. According to one aspect of the present disclosure, the relative time is correlated with “absolute” time to find a correction factor or time offset that defines the variation between the relative time and the absolute time. In another aspect, the time offset is applied to some or all of the event data sets transferred to the other components of the present system and the time corrected event data set(s) are transferred to other components of the system. In one aspect, the receiving component of the system calibrates and correlates the relative time to the correct absolute time and modifies the relative time associated with all of the transferred event data sets.

In certain embodiments, the present systems and methods further comprise devices with internal time keeping mechanisms, wherein said internal time keeping mechanism generally starts keeping time at the initial startup of the device and the beginning time is usually a predetermined time or random time relative to the device. According to one aspect, the time stamping device does not require a display or buttons for setting its internal timekeeping component(s). Further, the present systems and methods compensate for drift and skew as they relate to time and common errors associated with timekeeping devices.

### Exemplary Embodiment

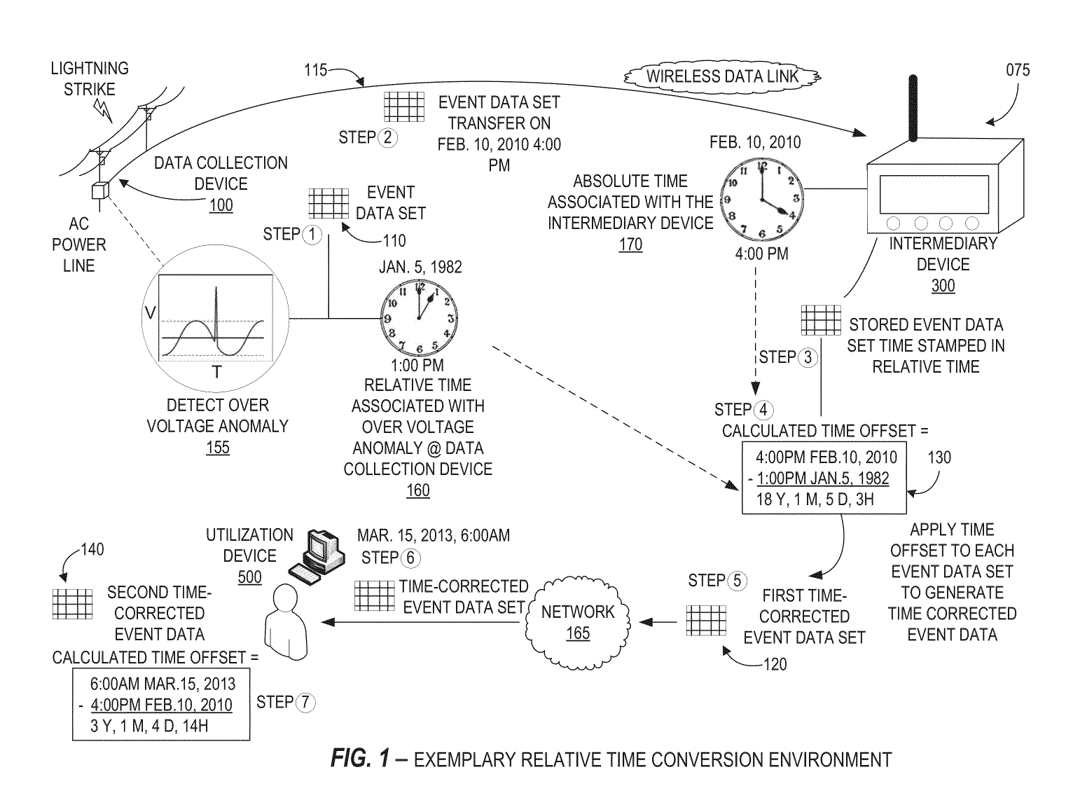

FIG. 1 illustrates a scenario involving the determination of absolute time corresponding to relative time-stamped events in the exemplary context of a remote voltage monitoring application. In this exemplary scenario, a remote voltage monitoring device, coupled to a data collection device 100, is coupled to an AC power line to monitor the voltage. Upon predetermined occasions (e.g. upon an overvoltage detection, an undervoltage detection, a power interruption, or other power line anomaly), the data collection device 100 transmits a time-stamped package of data (event data set) 115 indicating the occasion and the time at which it occurred—a time relative to a clock at the voltage monitoring device—to a remotely located intermediary device 300. The time-stamped data package may then be stored, analyzed, processed, and/or correlated with other events at the intermediary device 300. For example, the intermediary device may correlate the predetermined occasion such as a power overvoltage to the failure of electrical equipment coupled to the AC power line. That equipment failure may, or may not, be associated with the monitored occasion or event.

Optionally, the intermediary device 300 may further transmit the time-stamped data package 110 to a utilization device 500. Further, the intermediary device may generate a time-corrected event data set 120 and transmit that time-corrected event data set to the utilization device. For purposes of the present invention, it does not matter whether a time-corrected event data set is generated at an intermediary device 300 or at a further utilization device 500—the time-correction operations as described herein may be effected at either an intermediary device or at an ultimate utilization device.

Still referring to FIG. 1, a particular sequence of events in this exemplary scenario is illustrated sequentially as numbered circles. Assume that the actual or real time is 6:00 AM Mar. 15, 2014. Starting at step 1, a data collection device 100 (not specifically shown) comprising a voltage monitor is coupled to an AC power line to monitor voltage. The data collection device includes a real time clock (RTC) that has a relative time of shortly before 1:00 PM Jan. 5, 1982. This relative time is arbitrary and reflective of the fact that the data collection device does not contain any way to be set to the real time 6:00 AM Mar. 15, 2014. Assume that the voltage monitor detects an overvoltage condition or anomaly at 155, perhaps due to lightning strike on the power line, at relative time 1:00 PM Jan. 5, 1982. As shown at 155, the relative time associated with the overvoltage anomaly at the data collection device is 1:00 PM Jan. 5, 1982. An event data set 110 containing information relating to the overvoltage anomaly is associated with the relative time of 1:00 PM Jan. 5, 1982.

Assume that the data collection device 100 is coupled for data communications via a wireless data link to an intermediary device 300. Assume further that the time at the intermediary device is 4:00 PM Feb. 10, 2010, which is also arbitrary and reflective of the fact that the intermediary device may not be synchronized or referenced to the actual or real time of 6:00 AM Mar. 15, 2014. At step 2, the event data set 115 bearing the relative time of 1:00 PM Jan. 5, 1982 is transmitted to the intermediary device, where the time (also relative) is 4:00 PM Feb. 10, 2010. At step 3, the event data set 115 is stored in a memory associated with the intermediary device 300.

At step 4, the time difference between the relative time associated with the event data set 115 and the actual time associated with the intermediary device 300 is calculated, to obtain a time offset 130. In this example, the difference between the intermediary device time 4:00 PM Jan. 5, 1982 (at the intermediary device) and the relative time 4:00 PM Feb. 10, 2010, at the data collection device is 18 years, 1 month, 5 days, 3 hours. This time offset 130 is then applied by the intermediary device 300 to each event data set provided by the data collection device 100.

At step 5, a first time-corrected data set 120 is generated at the intermediary device 300, which contains the data indicative of the overvoltage anomaly 155 that occurred at 4:00 PM Feb. 10, 2010, relative to the intermediary device. This first time-corrected data set 120 may then be transmitted, e.g. via a data communications network 165, to a utilization device 500, where the actual or real time is 6:00 AM Mar. 15, 2013.

At step 6, the first time-corrected data set 120 is received at the utilization device 500 and stored, in a manner similar to that at step 3 at the intermediary device. At step 7, a further or second time offset is calculated to generate a second time-corrected event data 140, where the data from the intermediary device—which is relative to the time at the intermediary device—is time-corrected relative to the actual time as maintained by the utilization device 500. In like manner to that for the intermediary device, the second time offset is applied to each event data set to generate the second time-corrected event data 140.

It will be appreciated that the relative time correction according to this disclosure may be determined at an intermediary device separately from determination at a utilization device. It will further be appreciated that there may not be an intermediary device and that the time correction operation is effected at the utilization device. It will still further be appreciated that further and other devices, each having their own relative time standards, may be employed to provide data from a plurality of data collection devices 100 (not shown), each of which may have an independent RTC, so that a utilization device adjusts data from such a plurality of data collection devices for the purpose of correlating disparate and separate events to real time.

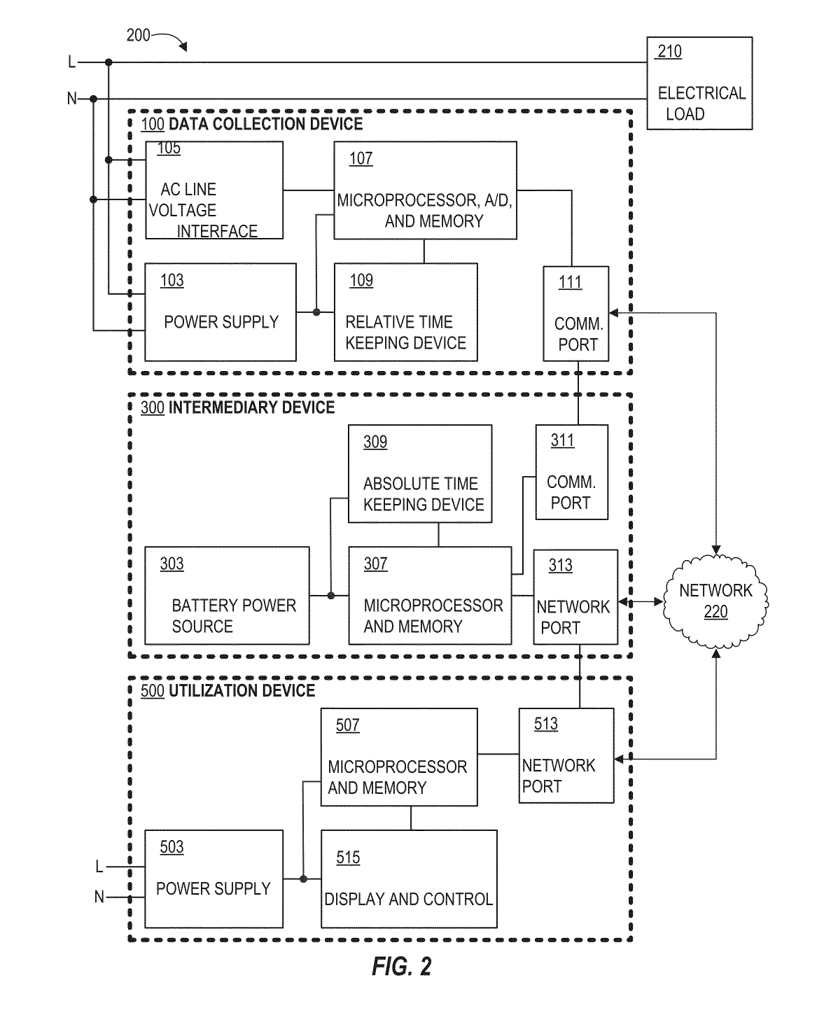

FIG. 2 illustrates a system 200 in accordance with the present disclosure adapted for an AC line voltage monitoring application, suitable for use in connection with the example discussed in connection with FIG. 1. According to an exemplary embodiment, the system 200 comprises a data collection device 100, an intermediary device 300, and a utilization device 500. The data collection device 100 typically collects and, utilizing a relative timekeeping device 109, time stamps data with relative time according to its local RTC. According to one aspect, data and time stamps are typically transferred to the intermediary device 300 before ultimately being transferred to the utilization device 500 for data observation and analysis by the user.

The exemplary embodiment shown in FIG. 2 is a voltage monitoring system that employs the data collection device to continually monitor an AC line voltage and time stamp the time and date at the instance of a line voltage deviation or anomaly. The data collection device comprises an AC line voltage interface 105 coupled to the electrical power line (shown coupled between line (L) and neutral (N)), a power supply 103, a microprocessor 107 that includes analog-to-digital conversion (A/D) and memory, a relative timekeeping device 109, and a data communication port 111. The electrical power line is coupled to a load 210.

While the AC line voltage interface 105 within the data collection device 100 interacts with a relative timekeeping device 109, a user does not set the time and date. When a deviation is sensed, the deviation type and time (the word “time” in this case refers to both the time of day, day, month, and year), but as will be understood by one of ordinary skill in the art time may refer to any format or component(s) of time at the instant of the occurrence. The data collection device 100 stores the time stamps and associated data for transmission at a later time via the data communication port 111. In one embodiment, the data communication port 111 is coupled to a data communication network 220 such as the Internet for communications with other system components. In one aspect, the data communication port 111 is coupled to the intermediary device 300. In another aspect, the data communication port 111 is coupled to the utilization device 500, either directly or via a data communication network 220 such as the Internet.

The data collection device 100 may not be permanently connected to a network, and thus cannot transfer its data automatically. In such a case, the data collected by the device is stored locally until a communication event occurs. The intermediary device 300 may retrieve the data from the data collection device 100 for later transfer to the utilization device 500. The intermediary device 300 (or any apparatus downstream) can then correct the received time stamps using other data sent along with the time-stamped data sets.

In one embodiment, the data collection device 100 comprises a line voltage interface 105 for receiving an input signal from an exemplary power source. According to one aspect, the line voltage interface 105 may step up or step down the voltage to levels appropriate for utilization by the AC line voltage monitoring system 200 and/or the data collection device 100.

In one embodiment, the data collection device 100 comprises a microprocessor 107 with an integrated A/D converter and non-volatile memory. In one aspect, the A/D converter converts the incoming analog signal representing AC line voltage measurements to a digital signal such that the microprocessor may be able to process and store the incoming data. According to another aspect, the microprocessor comprises an analyzation/comparison mechanism for detecting a plurality of voltage deviations and creating event data sets as such. According to another aspect, the non-volatile memory stores the identified data sets that will later be transferred to the intermediary device 300 or utilization device 500.

In one embodiment, the data collection device 100 comprises a relative timekeeping device or real time clock (RTC) 109 for maintaining a relative time associated with the data collection device 100. In one aspect, as an event data set is created, the microprocessor 107 obtains the relative time of the data collection device 100 from the relative timekeeping device 109 and time stamps the event data set. In another aspect, the relative timekeeping device 109 generally begins keeping time upon the initial startup of the device.

As discussed elsewhere, it will be understood that some timekeeping devices or real time clocks provided with electronic equipment reset to a predetermined initial time (e.g. 12:00 AM Jan. 1, 1970) on power-up, and continue to keep time from that initial time until set by an external process or control or until power interruption and power-up reset causes the time to again be set to the predetermined initial time. Advantageously, and in accordance with aspects the disclosure, data signals that are time stamped by the data collection device and system as described herein adjust for the relative time difference between a device such as data collection device 100 and other devices that have access and are synchronized to actual, real time.

In one another aspect, the RTC device 109 may be a long-running, battery powered device that is configured to free run from its initialization upon manufacture and continues to run independently for a long period of time, e.g. greater than 5 years. Examples of such devices include the M41TC8025 temperature-compensated real-time clock (RTC) with embedded crystal and the M41T62 Real-time clock (RTC) IC with embedded crystal available from STMicroelectronics, the DS1307 serial real time clock from Maxim Integrated, San Jose, Calif. 95134, and others. Those skilled in the art will understand that such free-running battery powered RTCs are often set to a predetermined time associated with the manufacturer, perhaps in a different time zone, and may also be subject to skew or drift as a function of temperature, age of components, external interference or tampering, or the like. Such RTCs will thus exhibit a relative time at the point of utilization, e.g. a data collection device 100 or intermediary device 300 as described herein. Teachings of the present disclosure as to relative time adjustment are likewise applicable to systems that employ such RTCs.

In one embodiment of the present disclosure, the data collection device 100 further comprises a communications port 111 for communicating and transferring data from the data collection device 100 to the intermediary device 300. As will be generally understood by one of ordinary skill in the art, the communications port 111 may comprises, a CAT 5 connection, a telephone connection, a wireless module, a USB connection, a lightning connection, or any connection of the like. In the example discussed in FIG. 1, the data communications port 111 comprises a wireless data link

Further and in one embodiment, the data collection device 100 may comprise a power supply 103 for providing the necessary DC voltage to power the microprocessor 107, the communications port 111, and/or the relative timekeeping device 109. In one aspect, the power supply 103 may comprise a full-wave bridge rectifier or some mechanism of the like for conversion of an AC power source to a DC power source. In another embodiment, the reliant components may utilize a low power AC source, wherein the power supply steps down the incoming power to a power usable by the adjoined components.

In one embodiment in connection with FIG. 2, the system is powered ON when the data collection device 100 and the power supply 103 is connected to the line voltage providing DC voltage to the microprocessor 107, the relative timekeeping device 109, and the communications port 111. Upon powering ON, the timekeeping device 109 starts to keep time from a known, initial starting point that is not the correct current synchronized or “absolute” time, and runs freely from that point forward. The timekeeping device is keeping what is referred to in this example as “relative” time. Even though the timekeeping device is not set to the correct current synchronized or “absolute” time, it still keeps time accurately (typically within a known or predetermined tolerance). A corollary to this would be a standard desk clock being set to the wrong time. The clock accurately counts seconds, hours, days, etc., but the time shown on the face of the clock is not synchronized to the current “absolute” time.

In one embodiment, the intermediary device 300 comprises a battery power source 303, an absolute timekeeping device 309, a microprocessor 307 and memory, a communication (comm.) port 311, and/or a network port 313 for retrieving event data sets from the data collection device 100 and/or communicating data to the utilization device 500. According to one aspect, the intermediary device may comprise a hand held unit, a separate unit operating in the cloud, a data accumulator that collects data from a plurality of associated data collection devices 100, etc. In one aspect, some or all components may be discrete and exist separately. In another aspect, some or all components may exist as in one unit or microprocessor.

According to one embodiment shown in FIG. 2, the intermediary device 300 comprises a microprocessor 307 with integrated non-volatile memory for performing various functions in connection with relative time-stamped data received from the data collection device 100. In one aspect, the microprocessor 307 may calculate the offset time of the relative time provided by the data collection device 100 and the absolute time received from an absolute timekeeping device 309. In another aspect, the microprocessor 307 applies the calculated offset time to at least one event data set received from the data collection device 100. In yet another aspect, the intermediate apparatus transfers the event data set(s) comprising the corrected time stamp to a utilization device 500.

In one embodiment, the microprocessor 307 with integrated non-volatile memory utilizes the memory to save various data. In one aspect, the non-volatile memory is utilized to save event data sets previously received from the data collection device 100. In another aspect, the non-volatile memory saves offset times and offset time calculation algorithms for correlating relative time to absolute time. In one aspect, the non-volatile memory saves event data with corrected time stamps, which data may be transferred to the utilization device 500.

In one embodiment, the intermediary device 300 comprises an absolute timekeeping device 309 for maintaining a correct absolute time. In one aspect, the microprocessor 307 retrieves and/or receives the correct absolute time from the absolute timekeeping device 309. In one aspect, the absolute time is generally set before the intermediary device 300 is placed in service. In another aspect, the intermediary device may be remotely set to the absolute time by data or signals received via the network port 313, or by an onboard time receiver (not shown) such as a model CMMR-6 WWVB NIST radio time receiver available from C-Max Time Solutions GmbH, Heilbronn, Germany or other similar radio time receiver.

In another embodiment, the intermediary device 300 comprises a relative timekeeping device 309 for maintaining time relative to the device, but independently of and relative to either an associated data collection device 100 or a utilization device 500. In one aspect, the microprocessor 307 retrieves and/or receives the locally indicated relative time from the relative timekeeping device 309. In one aspect, e.g. if using an independent battery-powered RTC, time is generally set before the intermediary device 300 is placed in service.

According to one embodiment, the intermediary device 300 further comprises a communications port 311 for communicating and receiving data from the data collection device 100 to the intermediary device 300. As will be generally understood by one of ordinary skill in the art, the communications port 311 may comprise, a CAT 5 connection, a telephone connection, a wireless module, a USB connection, a lightning connection, or any connection of the like.

In one embodiment, the intermediary device 300 further comprises a network port 313 for communicating and transferring data between the intermediary device 300 and the utilization device 500. As will be generally understood by one of ordinary skill in the art, the network port 313 may comprise a CAT 5 connection, a telephone connection, a wireless module, a USB or micro-USB connection, an Ethernet connection, an Apple Lightning connection, or similar data communication connection.

Further and in one embodiment, the intermediary device 300 may comprise a battery power supply 303 for providing the necessary DC voltage to power the microprocessor 307, the communications port 311, the network port 313, and/or the timekeeping device 309. In one aspect, the power supply 303 may comprise a battery for supplying a DC power source. In another embodiment, the battery power supply 303 may comprise a full bridge rectifier and a connection to the AC line and convert the AC signal to a usable DC signal for the plurality of dependent components.

In one embodiment, the utilization device 500 is constructed similarly to the data collection device 100 and intermediary device 300. For example, a typical utilization device comprises a microprocessor 507 with non-volatile memory, a network port 513, and a power supply 503, each of which perform similar functions as previously described in connection with the data collection device 100 and the intermediary device 300. In one aspect, the utilization device 500 further comprises a display and control component 515 that allows user interaction with the system. In this example, the utilization device 500 could be a remote computer server and control facilities such as a display and keyboard for executing various functions associated with the utilization device 500. Further, and according to one aspect, the utilization device may comprise a remote computer server, a server rack, a PC, a laptop, a tablet, or other similar data collection, storage, computation, and communication device.

As will be generally understood by one of ordinary skill in the art will, the functions within data collection device 100 and the intermediary device 300 are illustrated and described as separate blocks, but functions may be implemented discretely such as using an external A/D and memory or functions may be integrated together such as using a single microprocessor with on-board peripherals such as A/D, memory, communications port, a real time clock, etc.

In one embodiment, consistent with the discussion associated with FIG. 1 above, the system 200 stores event data sets comprising the power line anomaly or deviation types and a time stamp associated with a detected event, but as will be generally understood by one of ordinary skill in the art, the event data set could be expanded to store data values corresponding to voltage, current, frequency, etc. at the onset of, the recovery of, or at any point during the deviation. In addition, while this example is monitoring AC line voltage, the time stamping method could be used in any system, monitoring or otherwise, that requires a time stamp to be associated with an event and transferred to another system.

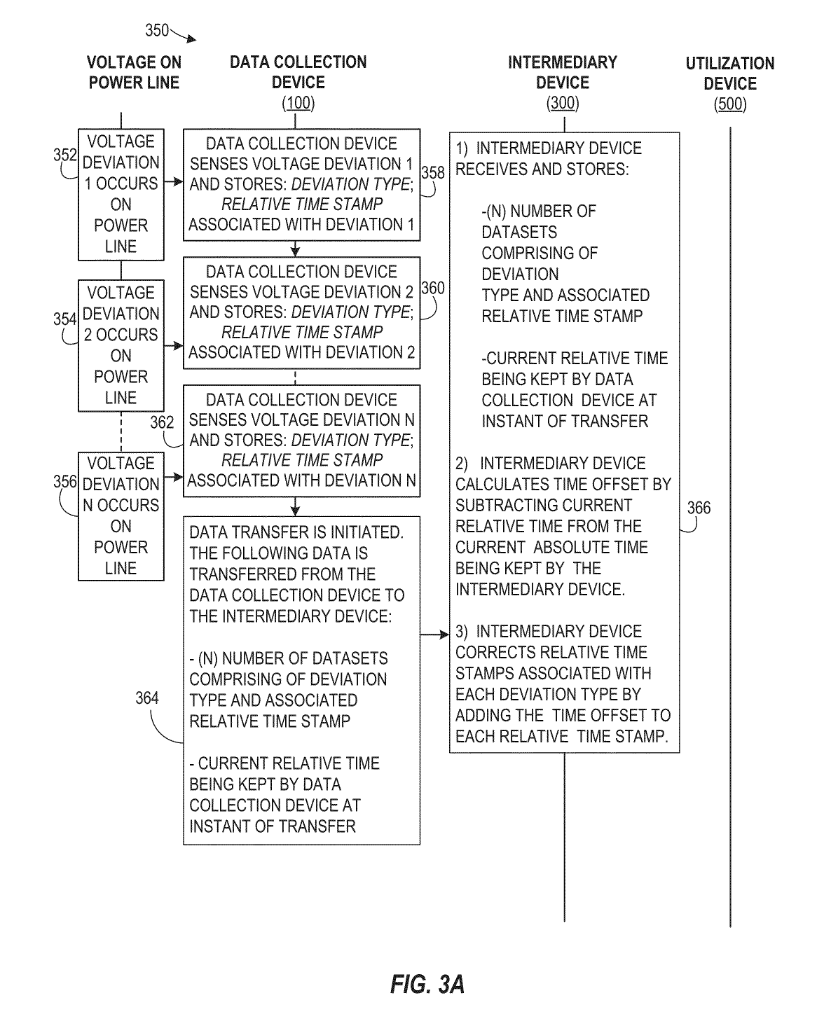

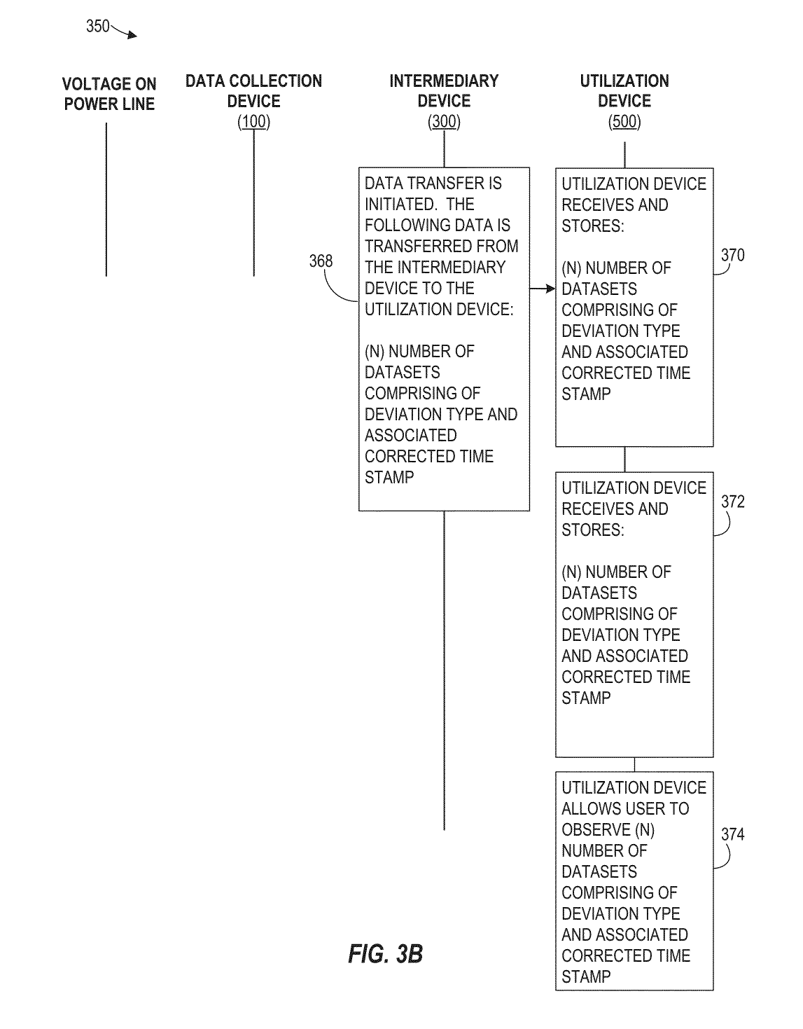

FIGS. 3A and 3B are a sequence diagram of an exemplary relative time stamping conversion process. In one embodiment, during normal operation the microprocessor 107 within a data collection device 100 continually samples the line voltage at a sample rate sufficient to determine if there is a voltage deviation. As shown in steps 352, 354, and 356 a voltage deviation may occur on one or a plurality of voltage lines and is collected by the data collection device, as illustrated in steps 358, 360, and 362. A voltage deviation is defined as a voltage level either higher or lower than the nominal or expected line voltage.

Detection of the deviation could be accomplished by comparing the current sample value with an expected theoretical value previously calculated based on the known voltage level and frequency of the line voltage being monitored by the microprocessor 107. If the current sample falls outside a window of values based on the expected value +/− an appropriate error, a deviation event is sensed and the microprocessor 107 records an event data set in the non-volatile memory (see steps 358, 360, and 362). In one aspect, an event data set comprises the following: deviation event type (such as an overvoltage, an under voltage, a frequency deviation, etc.) and the time stamp for that event (Ts) defined as the “relative” time associated with an event read from a non-synchronized, free-running timekeeping device 109 that has not been set to the correct time and date at the instant the deviation event was sensed.

In one embodiment, the microprocessor 107 continues to sample the line voltage and upon sensing any additional deviation events, records both the deviation event type and the associated “relative” time stamp (Ts). In one aspect, the total number of datasets may be limited by the physical memory installed in the data collection device 100. According to one aspect, the non-volatile memory clears itself after transferring the collected event data sets. In another aspect, the non-volatile memory must be erased and cleared manually.

In one embodiment, the data stored in the non-volatile memory within the microprocessor 107 of an associated line voltage monitoring system 200 may be transferred using the communications port 111 to the intermediary device 300 as shown in step 364. The intermediary device 300 could be any hand-held device or remote computer that contains its own timekeeping device synchronized to current “absolute” time, or may itself be associated with a relative time for the intermediary device. Alternatively, the communications port 111 could be a standard network port and the data sets would be transferred to a cloud server that contains its own timekeeping device synchronized to current “absolute” time.

At step 364 and during the transfer of the data sets (deviation event type and its associated “relative” time stamp (Ts)) from the line voltage monitoring system 100 to the intermediary device 300, the transferred data generally comprises deviation type, relative time stamp (Ts) for each deviation event, and the current relative time (Ttr) wherein, the current relative time is generally defined as the “relative” time at the instant the time-stamped information is being transferred from the line voltage monitor 100 to the intermediary device 300.

The intermediary device receives the event data sets and calculates an offset time as follows:

To=Tta−Ttr

wherein, To is the time offset, Tta is the “absolute” time read at the instant that time-stamped information is transferred from data collection device 100 to the intermediary device 300 as read from a timekeeping device located on the intermediary device 300 that has been set to the correct time and date (or is itself a relative time), and Ttr is defined as the relative time associated with the data set.

As shown in step 366, the time offset is calculated and each relative time stamp associated with a deviation type contained in each event data set may be corrected by the intermediary device 300 by adding and/or subtracting the time offset to each associated relative time stamp and storing the result as the associated corrected time stamp. The time stamps correction from its “relative” time format into “absolute” time format is executed using the formula:

Tsc=Ts+To

where Tsc is the corrected time stamp associated with the deviation type, Ts is the relative time stamp associated with the deviation type, and To is the offset time as calculated in the previous step. As shown in FIG. 3A and according to one embodiment, the calculation of the time offset and the correcting of the relative time stamps occurs within the intermediary device 300.

Referring to FIG. 3B, at step 370 a data transfer is initiated between the intermediary device 300 and the utilization device 500, wherein the data comprises at least one event data set with the corrected time stamp associated with each deviation type within the event data sets as shown in step 368. Typically, the utilization device 500 stores the incoming event data sets within its microprocessor and/or memory and enables a user to view the event data sets comprising the deviation type and corrected time stamp such that further analysis and actions may be executed, as shown in step 372.

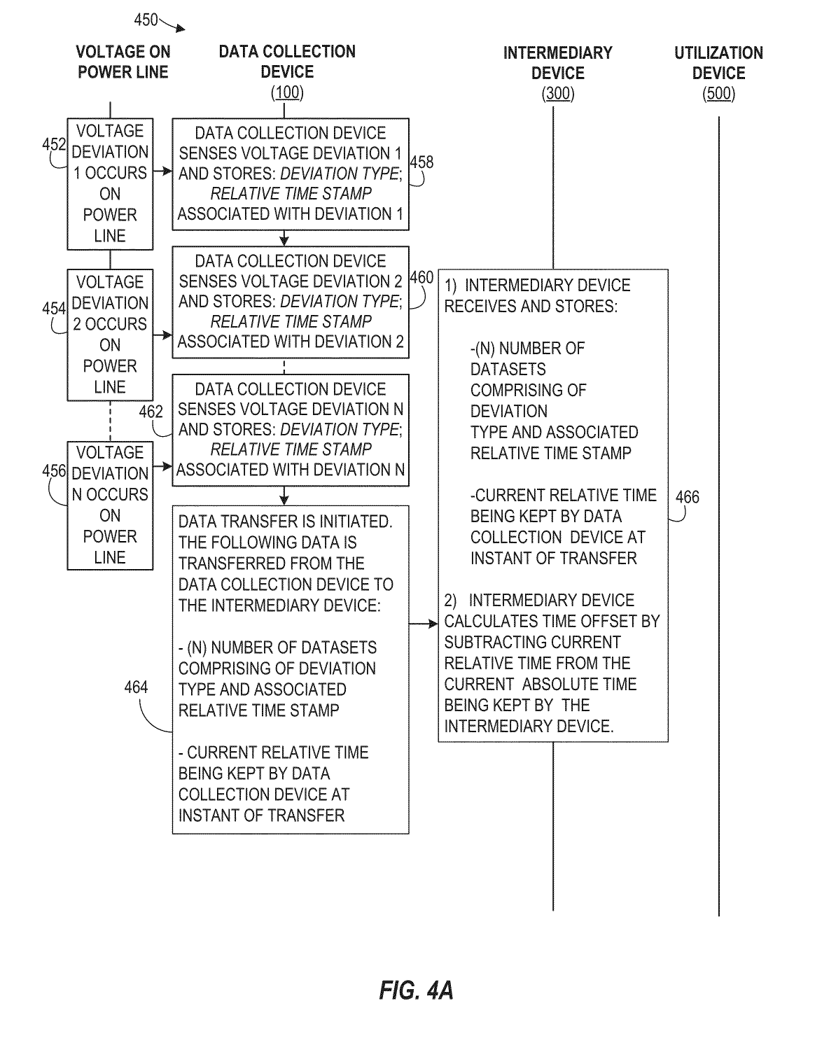

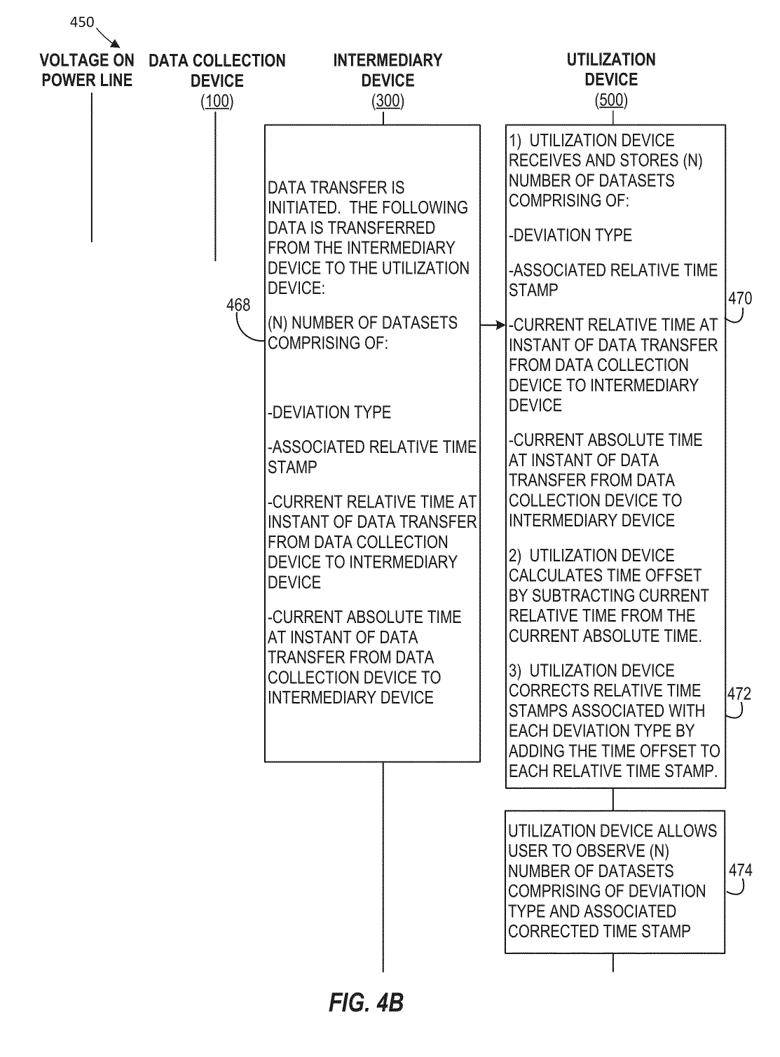

FIGS. 4A and 4B are an exemplary sequence diagram of a relative time stamp conversion process 450. The process of FIG. 4 is similar in some respects to the process of FIG. 3. However, in FIGS. 4A and 4B, a calculation of the time offset and the correcting of the relative time stamps associated with each deviation type occurs at the utilization device 500. Similar to FIGS. 3A and 3B, the data collection device 100 continually monitors the power line for voltage deviations. As a deviation is sensed, as shown in steps 452, 454, and 456, the data collection device 100 stores the event data sets comprising of the deviation type and the associated relative time stamp, illustrated in steps 458, 460, and 462.

In step 464, as a data transfer is initiated, the stored event data sets comprising the deviation type and relative time stamp are transferred along with the current relative time to the intermediary device 300. However, the process of FIGS. 4A and 4B differs from the process illustrated in FIGS. 3A and 3B in that within the intermediary device 300, each event data set is appended with the current relative time at the instant of data transfer, as well as with the time relative to the intermediary device at the instant of the data transfers as kept by the timekeeping device in the first intermediary device, as illustrated in step 468. Under the condition the new data set (deviation type, associated relative time stamp, current relative time at instant of data transfer, and current absolute time at instant of data transfer) is maintained intact, calculation of the time offset, and subsequently, correction of the associated relative time stamps can occur at any additional intermediary point, or at the utilization device 500.

Referring to FIG. 3B and at step 470, data is transferred from the intermediary device 300 to the utilization device 500, wherein the data comprises at least one event data set including deviation type, associated relative time stamp, current relative time stamp and/or current absolute time stamp. Subsequently, the utilization device 500 receives the event data sets, as shown in step 472 and the time offset is calculated, whereby each relative time stamp associated with a deviation type contained in each event data set may be corrected by adding and/or subtracting the time offset to each associated relative time stamp and storing the result as the associated corrected time stamp. Further and according to one aspect, the utilization device 500 enables a user to view the event data sets comprising the deviation type and corrected time stamp such that further analysis and actions may be executed, as shown in step 474.

In one aspect, FIGS. 4A and 4B illustrate a process wherein the time-stamped data originates at the data collection device 100 and is transferred to an intermediary device 300. The current relative time and current absolute time are appended to the original data set, and subsequently transferred to a utilization device 500, whereby the time offset and time stamp correction is performed. As will be generally understood by one of ordinary skill in the art, any number (N) of additional intermediary devices 300 may be inserted in the data path and that in any of these additional intermediary devices, the time offset calculation by itself or the time offset calculation as well as the time stamp correction may be performed.

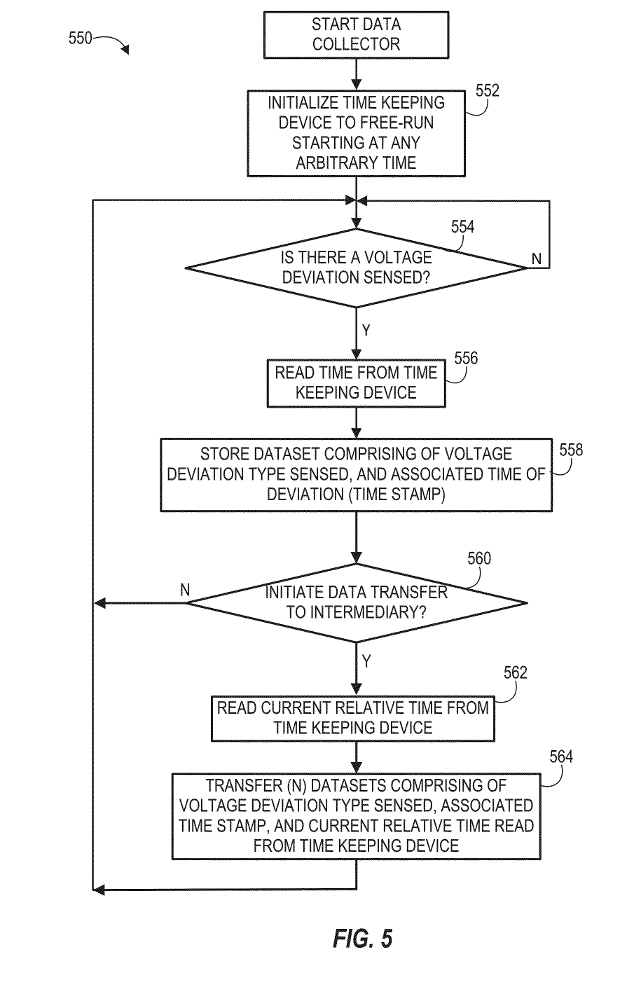

FIG. 5 is a flow chart of an exemplary computer program module 550 executed in the data collection device 100, according to one aspect of the present disclosure. In one aspect and as previously described, the relative timekeeping device 109 of a data collection device 100 is initialized as the data collection device 100 is powered ON as shown in step 552. In the data collection device 100, the relative timekeeping device109 is running and counting time accurately, but from an arbitrary or predetermined initialization point, it being understood that the data collection device 100 may have no mechanism to set the timekeeping device to the correct time and date.

According to one aspect, the power line is generally continuously monitored by the data collection device 100, which identifies voltage deviations as illustrated at step 554. As a the data collection device 100 senses a voltage deviation, the time and/or date is read and stored in memory along with the type of voltage disturbance (see steps 556 and 558). In one aspect, the data collection device 100 may continue monitoring the power line and continue compiling additional event data sets comprising deviation type and time stamps, which are stored in memory. In another aspect, the data collection device 100 may initiate a transfer of at least one event data set, as shown in step 560.

As illustrated at step 562, at an initiation of a data transfer from the data collection device 100 to the intermediary device 300, the current relative time is read from the relative timekeeping device 109 within the data collection device 100. All event data sets stored in the data collection device memory 107 are transferred along with the current relative time to the intermediary device 300, as shown in step 564.

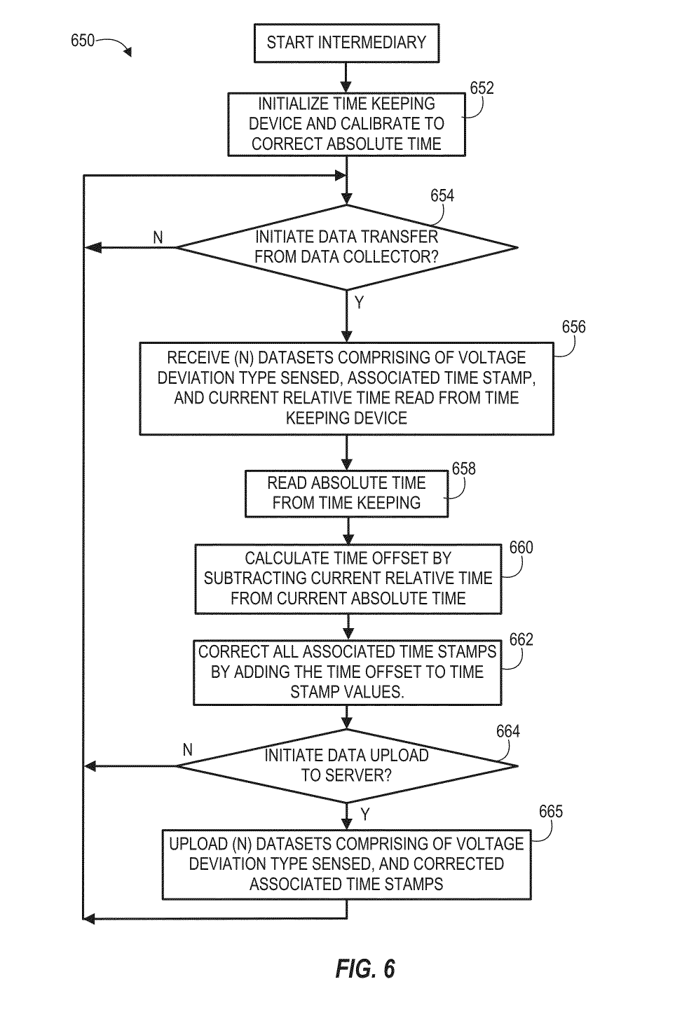

FIG. 6 a flow chart of an exemplary computer program module 650 executed in an intermediary device 300. Starting at step 652, the timekeeping device of the intermediary device 300 is initialized and optionally calibrated to the correct absolute time, if an absolute time reference is available or the time can be set by a user. The intermediary device 300 may contains a facility to set the correct time and date, such as buttons, toggle switches, a display, and/or mechanisms of the like. At the moment of data transfer, as illustrated in step 654, the intermediary device receives event data sets from the data collection device 100. As shown in step 656, the intermediary device 300 receives at least one event data set comprising a deviation type, an associated relative time stamp, and a current relative time read from the relative timekeeping device 109. In step 658, as the data is received, the timekeeping device 309 within the intermediary device 300 is documented and is set as the current time (which may be relative or absolute) relating to the current relative time received from the data collection device 100.

In one aspect, a time offset is calculated by subtracting the current relative time passed at the time of data transfer from the current time as reflected by the timekeeping device 309 in the intermediary device 300, as shown in step 660. The time offset is used to correct each individual time stamp associated with each deviation type, illustrated in step 662. The corrected time stamp is then stored in the memory associated with the microprocessor 307 and non-volatile memory along with the deviation type. As illustrated in steps 664 and 665, the intermediary device may upload or transfer corrected time-stamped data to a utilization device 500. According to one aspect, the intermediary device 300 may continue to receive and store event data sets from the data collection device 100 and compile additional data to send in a consolidated upload to the utilization device 500.

As will be generally understood by one of ordinary skill in the art, in connection with the aforementioned descriptions of FIGS. 4 and 5, generally the timekeeping device in the data collection device 100 is initialized with a time and date before or earlier in time than the time and date set on the timekeeping device located in the intermediary device 300. Therefore, the methodology for calculation of the time offset and correction of the individual time stamps was presented accordingly. Further, as will occur to one of ordinary skill in the art, the described methodology of calculating a time offset is for exemplary purposes only and a similar methodology may be employed if the timekeeping device in the data collection device 100 is set to an arbitrary time after or later in time than the time and date set on the timekeeping device within the intermediary device 300 or under any other condition.

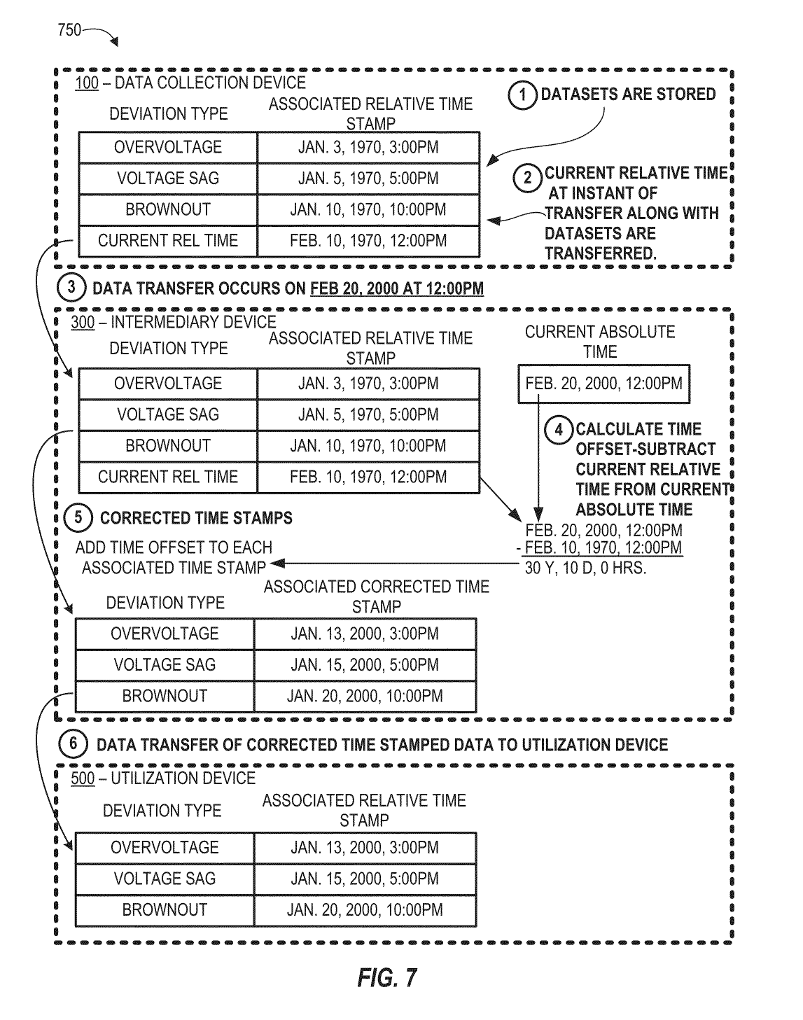

FIG. 7 illustrates an exemplary process 750 of how the time offset is calculated by subtracting the current relative time from the current absolute time, according to one aspect of the present disclosure. Further, FIG. 7 illustrates an exemplary memory map as well as a process of how the data is created and stored in memory within the data collection device 100, the intermediary device 300, and the utilization device 500. The numbered circles in FIG. 7 correspond to steps of the exemplary process, for ease of understanding.

In one aspect, step 1 illustrates a memory map for an exemplary data collection device 100 depicting a deviation type stored adjacent to its associated relative time stamp forming an initial exemplary data set. However, as will be appreciated by one of ordinary skill in the art, the data does not need to be stored in adjacent storage locations. Further, and according to another aspect, event data sets may continue to be created until a transfer from the data collection device 100 to an intermediary device 300 is initiated.

According to one aspect and as illustrated in step 2, the last data set is created by reading the time from the relative timekeeping device 109 and associating this with a special deviation type marked as the current relative time. Subsequently, the memory map is transferred to the intermediary device 300, wherein the memory map may contain all or a portion of the created event data sets, as shown in step 3. In one aspect, upon transfer of the memory map, the intermediary device 300 interprets the time stamp in the last data set as the current relative time by reading the deviation type marked as the current relative time, illustrated in step 4. The intermediary device 300 reads the current absolute time representing the current time kept on the timekeeping device 309 of the intermediary device and calculates the time offset by subtracting the current relative time from the current time as maintained by the timekeeping device (which may itself be relative, or may be absolute time). Shown in step 5 and within the intermediary device 300, the associated relative time stamps are corrected by adding the time offset to each of the associated relative time stamps and stored in memory. Further, the memory map containing the deviation type and associated corrected time stamps may then be transferred to the utilization device 500 as shown in step 6.

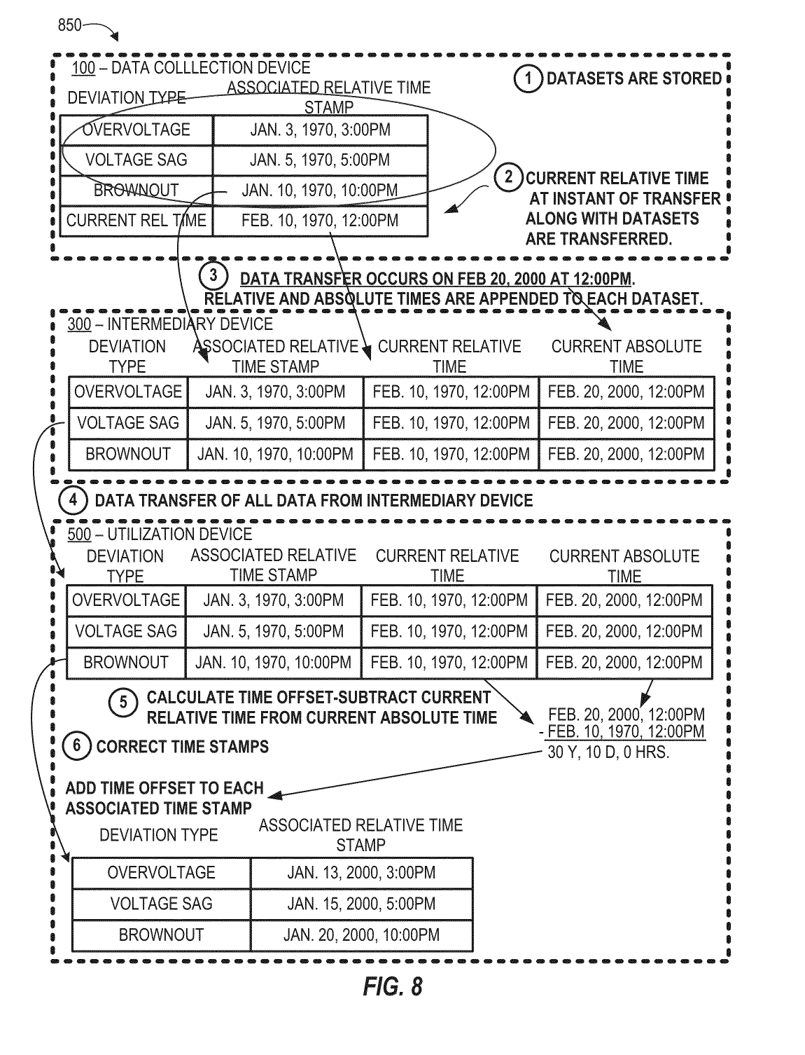

In another embodiment, FIG. 8 illustrates, similar to FIG. 7, an alternative process 850 of how data is created and stored according to another aspect, wherein the data is passed among multiple devices. In the example shown, the calculation of the time offset and correction of the associated relative time stamps is performed at the utilization device 500. In step 1, the exemplary memory map for the data collection device 100 shows that the deviation type is stored adjacent to its associated relative time stamp, forming an initial data set. However and as previously described, it will be understood that the data does not need to be stored in adjacent storage locations. In one aspect, more data sets may continue to be generated until an event data set transfer is initiated. At or near the time of transfer, the last data set is created by reading the time from the relative timekeeping device 109 and associating this with a special deviation type marked as the current relative time, as shown in step 2. In step 3, the entire memory map is transferred to the intermediary device 300.

In the intermediary device 300, each individual event data set is appended with the current relative time as transferred as the last data set, as well as the current time as read from its timekeeping device in the intermediary device at the instant of data transfer. In this instance and as will be understood by one of ordinary skill in the art, there could be any number (N) of additional intermediary devices 300, wherein the entire memory map could be transferred from one intermediary device to the next. As shown in step 4, data is transferred from the intermediary device 300 to a utilization device 500. A time offset may be calculated within the utilization device 500, by subtracting the current relative time appended to a specific data set from the current absolute time also appended to the same data set, as illustrated in step 5. In step 6, the associated relative time stamps for each data set are corrected by adding the time offset calculated for that particular data set to the associated relative time stamp for that particular data set.

As will be understood by one of ordinary skill in the art, FIGS. 7 and 8 depict instances where the calculation of time offset and correction of the time stamps occur either in the first intermediary device 300 or in the utilization device 500; these two steps are independent of each other and can be performed at different stages. For example, the calculation of time offset could be performed in the first intermediary device 300 or any subsequent intermediary device, or in the utilization device 500. Similarly, the correction of the time stamps using this time offset may be performed either within the same intermediary device 300 or utilization device 500 that calculated the time offset, or in any intermediary device or utilization device that the data is subsequently transferred.

As should now be understood from the discussion above, a relative timekeeping device 109 within a line voltage monitoring system 200 constructed as described herein does not require the time to be set by a user. In addition, the time is more accurate as drift is accumulated between the time of the deviation event and the time the event data set(s) are transferred to the intermediary device 300, rather than drift accumulating from the time the clock was set to the time the deviation event occurred. While the example given is for a line voltage monitoring system 200, this method can be implemented in any data collection system or any other type of apparatus with an on-board timekeeping device (such as an RTC). Also, while the example given shows a line voltage monitor that is self-contained (without any permanent connection to a computer or computer network), this methodology could be used with any data collection or other type of apparatus containing a permanently connected network or data buss connected directly to a local computer or network. As will be generally understood by one of ordinary skill in the art, the aforementioned exemplary discussion is not intended to limit the spirit or scope of the present disclosure, but to serve as an exemplary discussion.

In the above example, the known starting point of the free running timekeeping device is a time and date some time before the current “absolute” time. However, the method could also be used with timekeeping devices that start with a time and date after the current “absolute” time by simply taking the absolute value of the time offset and subtracting it from the relative time associated with the deviation event (Ts), rather than adding as shown above.

In certain embodiments, the timekeeping device in the originating apparatus (in the example above, the data collection device 100) may have a backup power source in the form of either a battery or a super-capacitor. In such instances, the timekeeping device will keep running even if the line voltage is OFF. However, if the line voltage is OFF for a long enough period of time, it is possible that the backup power source will lose its charge and the timekeeping function stops. When the line voltage returns, the timekeeping device will once again start at a pre-designated starting point, and any stored time stamps will not be able to be corrected. In this instance, the stored time stamps are marked by the originating apparatus as possibly faulty before transferring to the end or utilization device 500. The utilization device 500 can attempt correction of the time stamps by reviewing the time and date of previous successful transmissions and applying an estimated time and date.

Accordingly, it will be understood that various embodiments of the present system described herein are generally implemented as a special purpose or general-purpose computer including various computer hardware as discussed in greater detail below. Embodiments within the scope of the present disclosure also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote memory storage device. It will be appreciated that the network connections described or shown are exemplary and other mechanisms of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A system for determining absolute time corresponding to relative time-stamped events, comprising:
a data collection device comprising an event monitoring component for obtaining data corresponding to a monitored event, a control component, a memory, a data communication port, and a real time clock (RTC), the RTC providing time signals that are unsynchronized to absolute time for association with data from the event monitoring component;
the control component in the data collection device operative to receive data corresponding to a monitored event and associate a time stamp derived from the RTC with the monitored event data and store time-stamped monitored event data in the memory;
a second device comprising a control component, a memory, a data communication port, and a second real time clock (RTC), the second RTC providing time signals for association with data received by the second device;
the second device coupled for data communications to the data collection device via their respective data communication ports;
the control component in the second device operative to receive time-stamped monitored event data from the data collection device;
the control component in the second device operative to associate a time stamp derived from the RTC in the second device with the time-stamped monitored event data received from the data collection device;
the control component in the second device operative to calculate a time offset for the time-stamped monitored event data comprising the difference between the time provided by the RTC in the data collection device and the time provided by the RTC in the second device, and associate the time offset with the time-stamped monitored event data; and
the control component in the second device operative to provide the time-stamped monitored event data and the time offset as an output for utilization.

2. The system of claim 1, wherein the second device is an intermediary device.

3. The system of claim 1, wherein the second device is a utilization device.

4. The system of claim 1, wherein the RTC in the second device provides time signals that are unsynchronized to absolute time.

5. The system of claim 1, wherein the RTC in the second device provides time signals that are synchronized to absolute time.

6. The system of claim 1, wherein the RTC in the data collection device lacks any means for synchronizing or being set to absolute time.

7. The system of claim 1, wherein the event monitoring component is an electrical power voltage monitoring device.

8. The system of claim 1, wherein the data collection device accumulates a plurality of data items corresponding to a plurality of monitored events, each of which is associated with a time stamp corresponding to the time of the event as determined by the RTC of the data collection device, and wherein the data collection device transmits the plurality of data items to the second device as a block of time-stamped monitored event data corresponding to said plurality of monitored events.

9. The system of claim 1, wherein the second device associates the block of time-stamped monitored event data with the time stamp derived from the RTC in the second device.

10. A method for determining absolute time corresponding to relative time-stamped events, comprising:
at a data collection device including an event monitoring component, obtaining data corresponding to a monitored event;
at the data collection device, associating a time stamp derived from a real time clock (RTC) with the monitored event data, the RTC providing time signals that are unsynchronized to absolute time;
transmitting time-stamped monitored event data from the data collection device to a second device via a data communications port;
receiving time-stamped monitored event data from the data collection device at the second device;
at the second device, associating a time stamp derived from a second RTC in the second device with the time-stamped monitored event data received from the data collection device, the second RTC providing time signals for association with data received by the second device;
at the second device, calculating a time offset for the time-stamped monitored event data comprising the difference between the time provided by RTC in the data collection device and the time provided by the second RTC in the second device, and associating the time offset with the time-stamped monitored event data; and
providing the time-stamped monitored event data and the time offset as an output from the second device for utilization.

11. The method of claim 10, wherein the data collection device comprises an event monitoring component for obtaining data corresponding to a monitored event, a control component, a memory, a data communication port, and a real time clock (RTC), the RTC providing time signals that are unsynchronized to absolute time for association with data from the event monitoring component, and wherein the control component in the data collection device receives data corresponding to a monitored event and associates a time stamp derived from the RTC with the monitored event data and stores time-stamped monitored event data in the memory.

12. The method of claim 10, wherein the second device comprises a control component, a memory, a data communication port, and a second real time clock (RTC), the second RTC providing time signals for association with data received by the second device, and wherein the control component in the second device receives time-stamped monitored event data from the data collection device and associates a time stamp derived from the RTC in the second device with the time-stamped monitored event data received from the data collection device.

13. The method of claim 12, wherein the control component in the second device calculates the time offset for the time-stamped monitored event data.

14. The method of claim 10, wherein the second device is an intermediary device.

15. The method of claim 10, wherein the second device is a utilization device.

16. The method of claim 10, wherein the RTC in the second device provides time signals that are unsynchronized to absolute time.

17. The method of claim 10, wherein the RTC in the second device provides time signals that are synchronized to absolute time.

18. The method of claim 10, wherein the RTC in the data collection device lacks any means for synchronizing or being set to absolute time.

19. The method of claim 10, wherein the event monitoring component is an electrical power voltage monitoring device.

20. The method of claim 10, wherein the data collection device accumulates a plurality of data items corresponding to a plurality of monitored events, each of which is associated with a time stamp corresponding to the time of the event as determined by the RTC of the data collection device, and wherein the data collection device transmits the plurality of data items to the second device as a block of time-stamped monitored event data corresponding to said plurality of monitored events.

21. The method of claim 20, wherein the second device associates the block of time-stamped monitored event data with the time stamp derived from the RTC in the second device.

22. A method for determining absolute time corresponding to relative time-stamped events, comprising:
at a data collection device including an event monitoring component, obtaining data corresponding to a monitored event;
at the data collection device, associating a time stamp derived from a real time clock (RTC) with the monitored event data, the RTC providing time signals that are unsynchronized to absolute time;
transmitting time-stamped monitored event data from the data collection device to an intermediary device via a data communications port;
receiving time-stamped monitored event data from the data collection device at the intermediary device;
at the intermediary device, associating a time stamp derived from a second RTC in the intermediary device with the time-stamped monitored event data received from the data collection device, the second RTC providing time signals for association with data received by the intermediary device, the RTC providing time signals that are unsynchronized to absolute time;
transmitting time-stamped monitored event data and time stamp derived from the second RTC from the intermediary device to a utilization device via a data communications port;
receiving time-stamped monitored event data and time stamp derived from the second RTC from the intermediary device at the utilization device;
at the utilization device, calculating a time offset for the time-stamped monitored event data comprising the difference between the time provided by RTC in the data collection device and the time provided by the second RTC in the intermediary device, and a time provided by an RTC in the utilization device;
associating the time offset with the time-stamped monitored event data; and
providing the time-stamped monitored event data and the time offset as an output for utilization.
